(19) United States
(12) Patent Application Publication
(10) Pub. No.: US 2023/0248099 A1
(43) Pub. Date: Aug. 10, 2023

(54) METHOD AND DEVICE FOR PROVIDING AT LEAST ONE CUTTING PATTERN FOR AN ARTICLE OF CLOTHING TO BE PRODUCED INDIVIDUALLY FOR A CUSTOMER

(71) Applicant: OpenDress GmbH, Konstanz (DE)

(72) Inventors: Verena ZIEGLER, Konstanz (DE); Frauke LINK, Konstanz (DE)

(21) Appl. No.: 17/785,973

(22) PCT Filed: Dec. 10, 2020
(86) PCT No.: PCT/EP2020/085506

§ 371 Date: Apr. 11, 2023

(30) Foreign Application Priority Data
Dec. 16, 2019 (DE) 102019008689.9

(51) Int. Cl. A41H 3/04; A41H 3/00; G06T 17/20

(52) U.S. Cl. CPC A41H 3/04; A41H 3/007; G06T 17/20; G06T 2210/16

(57) ABSTRACT

The present invention relates to a method, a computer program product, and a device for providing at least one cutting pattern of a garment to be made individually for a customer. Here, the method comprises the steps of:
creating a virtual individual 3D body model (20) of the customer based on individually determined 3D body shell data (10) of the customer and general skeletal data (30) provided;
creating a virtual individual 3D garment (40) based on a virtual 3D ideal design (30) and the virtual custom 3D body model (20) created;
creating the at least one cutting pattern by flattening/developing the virtual individual 3D garment (40), wherein flattening/developing the virtual individual 3D garment (40) takes place algorithmically on the basis of at least one set of cutting rules (52, 54).

The invention relates to a method, a device, and a computer program product for providing at least one cutting pattern of a garment to be made individually for a customer.

To purchase an individual or made-to-order garment, a customer conventionally will go to a tailor who takes measurements of the customer to make the garment. To do this, the tailor uses a tape measure, i.e. two-dimensional (2D), depending on the garment, to determine certain dimensions of the customer’s body, such as back length, arm length, leg length, waist length, waist size, belly size, back width, neck size, thigh size, bust size, etc. Since the invention of sewing patterns around 150 years ago, an already existing standard cutting pattern of the garment to be made individually is then customized based on these linear measurements in order to finally make the individual or made-to-order garment for the customer on the basis of the customized cutting pattern. For women, for example, the standard cutting pattern is based on a pattern construction for a height of 168 centimeters and a figure with a hip circumference of around 97 cm for size 38. The standard cutting pattern is then customized by scaling the cutting pattern shape according to certain principles (grading). Measurements can be taken either manually (e.g. by the tailor using a tape measure) or in an automated way using a body scanner. In both cases, linear measurements (i.e. measurements in 2D) are taken on the customer’s body or specific measurements required to make the garment are determined.

Conventional processes for creatomg a cutting pattern (e.g. according to “Müller+Sohn”) are based on existing basic cuts or basic patterns for smaller standard sizes. These cannot be scaled at will without becoming bulky or wrinkling in the realization. In the sewing process, analog readjustments have to be made several times in order to achieve a good result, for example by using darts. Further information on such conventional processes can be found e.g. in the book “Historische Schnitte HAKA: Schnittkonstruktionen” by the German Clothing Academy Munich, Rundschau-Verlag Otto G. Königer, 2001, ISBN-13: 978-3929305173, or in S. Stofer, M. Stiegler and L. Krolopp: “Schnittkonstruktionen für Jacken und Mäntel: M. Müller & Sohn”, Rundschau Verlag, 24th edition, 1994, ISBN-13: 978-3929305036, or in W. Schierbaum: “Bekleidungs-Lexikon: Mode, Formgestaltung, Schnittkonstruktion, Gradierung, Ausstattung, Zuschnitt, Verarbeitungstechnik, Bugeln, Management u. Marketing″, Schiele & Schön, 2nd edition, 1982, ISBN-13: 978-3794903740.

In the context of the present invention, it was recognized in particular that the conventional taking of measurements with regard to the accuracy of fit is insufficient in many cases, since the measurements conventionally carried out do not take any curvatures (or three-dimensional peculiarities) of the human body into account. For example, several people can have the same linear body dimensions (in 2D), but the 3D structures of the respective bodies (morphotypes) are completely different. A garment made individually using conventional methods would therefore lead to different fitting accuracy for these people.

It is therefore an object of the present invention to provide a method for creating a cutting pattern of a garment to be made individually for a customer, on the basis of which the garment can be made even more true to size compared to conventional methods, especially for people whose body shape deviates from standard clothing size models. In addition, it is an object of the present invention to provide a corresponding device and a corresponding computer program product. This object is solved by the subject matters of the independent claims. Advantageous embodiments are subject of the dependent claims.

A first independent aspect for solving the object relates to a method for providing at least one cutting pattern of a garment to be made individually for a customer, comprising the steps of:
creating a virtual individual 3D body model of the customer based on individually determined 3D body shell data of the customer and general skeletal data provided;
creating a virtual individual 3D garment based on a virtual 3D ideal design and the virtual custom 3D body model created;
creating the at least one cutting pattern by flattening/developing the virtual individual 3D garment, the flattening/development of the virtual individual 3D garment taking place algorithmically on the basis of at least one set of cutting rules.

In particular, the method comprises one or more of the following steps:
providing general skeletal data or a virtual skeleton;
providing, in particular generating or determining, virtual individual 3D body shell data or an avatar of the customer;
providing a virtual 3D ideal design of the garment to be made.

“General skeletal data” (also referred to below as “standard skeletal data”) is understood to mean data that represents a general virtual skeleton or a virtual standard skeleton. In particular, the standard skeletal data or the virtual standard skeleton comprises virtual nodes or node points. Furthermore, the standard skeletal data can comprise virtual connection elements with which at least some of the virtual nodes are connected to one another. The virtual nodes represent reference or anchor points of the virtual skeleton. In particular, the virtual nodes can e.g. represent joints of the skeleton and the virtual connecting elements can represent bones of the skeleton. Preferably, the standard virtual skeleton comprises at least 24 virtual nodes.

“Individual 3D body shell data” is understood to mean data for the virtual or graphic representation of an individual body shape or body shell of the customer. The individual 3D body shell data can relate to or represent at least one (relevant) body section of the customer. The individual 3D body shell data can therefore relate to or represent only one or more specific areas or sections of the customer’s body, or also relate to or represent the entire body of the customer. With the help of the individual 3D body shell data, an “avatar” of the customer can be created. An avatar is generally an artificial person or a virtual or graphic representative of a real person. Accordingly, an avatar in the context of the present application is understood as a virtual and/or graphic representation of the customer, which is made possible using or based on the individual 3D body shell data.

The 3D body shell data of the customer (a real person) can be generated with the help of a smartphone or tablet via an app, for example. Both “ARCore” (based on Android) and “ARKit” (based on iOS) are augmented reality frameworks that can be used to generate 3D body shell data, for example. In particular, “ARCore” and “ARKit” are a standard interface code between a sensor and software or an app that can be used to gather general point clouds of the environment and return them to the app. With the help of these augmented reality frameworks, 3D structures can be captured via the sensors built into smartphones. They thus enable 3D scanning and reconstruction of real objects. The orientation of objects in space can also be measured. For this purpose, algorithms from the field of computer vision are used in particular in connection with other sensors (e.g. position sensor, orientation sensor, etc.). As an alternative to a smartphone or tablet, a 3D scanner specially designed to generate the 3D body shell data can also be used. Since the 3D body shell data is generated by scanning the customer or relevant areas or body parts of the customer, the 3D body shell data can also be referred to as 3D scan data.

Instead of sensors, it is also possible to carry out or reconstruct a 3D scan using the video function of mobile devices (smartphones, tablets) or computers. In particular, it is possible to use techniques that combine neural networks with a “deep learning” approach and are known under the term “deep networks”. In particular, full-body renderings of a person or of the customer can be generated for different body positions (different poses). This approach forms a middle road between classic, two-dimensional graphic image elements (texture map of the model surface) and a “deep learning” approach that generates images of people using image-to-image translation. For example, a fully convolved network (neural network) can be used to directly map the configuration of body feature points of the camera to 2D texture coordinates of the individual pixels in the image frame. In this way, realistic renderings can be trained using videos with 3D poses and combined with foreground masks (image elements/texture display).

The 3D body shell data or scan data comprises in particular what is known as a “mesh” (3D mesh) or corresponding mesh data (3D mesh data). In computer graphics, a “mesh” (which can be generated by scanning, e.g. with a 3D scanner or a smartphone or tablet) is a 3D mesh or polygon mesh to describe the surfaces of an object. A mesh or 3D surface network is thus a collection of nodes, edges and surfaces that defines the shape of a polyhedral object. The surfaces usually consist of triangles (“triangle mesh”), squares or other simple convex polygons. The 3D body shell data or mesh data thus comprises in particular virtual triangles, virtual squares or other virtual polygons, which are generated by a scanning process with a 3D scanner or a smartphone or tablet. There are a number of well-known data structures for storing polygon meshes, such as the node list, the edge list, “winged edge”, and the doubly connected edge list (“doubly connected halfedge list”).

A “virtual 3D ideal design” of the garment to be made is understood to mean in particular design data with which an ideal garment to be made can be represented virtually or graphically. In particular, the virtual 3D ideal design comprises data on all properties (e.g. shape, relative dimensions, material, etc.) and/or special features (e.g. zipper, puff sleeves, decorations, etc.) of the garment to be made.

A virtual individual 3D body model of the customer is generated on the basis of the customer’s individually determined 3D body shell data and the specified general skeletal data. In particular, the determined 3D body shell data of the customer is linked to the specified general skeletal data in order to thus generate the virtual individual 3D body model or corresponding individual 3D body model data. The link can be made, for example, with the help of a neural network that has learned such a link. Figuratively speaking, the virtual skeleton is laid or placed in the determined virtual 3D body shell of the customer or in the scan that was carried out.

During the 3D scanning process, in particular a 3D point cloud is generated (e.g. a triangulated mesh or network is visualized in the virtual representation of the data). Since defects or holes in the scan can occur during the scanning process (e.g. by concealment in the armpit area) and no data points are captured at these locations, it is desirable to produce a closed surface. For this purpose, the scan data can be prepared virtually with an ideal 3D model (avatar). First, the 3D scan can be registered with the avatar (i.e. the scan and the avatar are superimposed locally and thus “mapped” or “matched”), so that the position and the orientation of the 3D scan and avatar in space are substantially identical. A possible execution of the registration of the scan data with an ideal mesh is possible e.g. by using a virtual skeleton, which is placed over the 3D scan as well as over the avatar using anchor points or with the so-called “iterative closest point” (ICP). Locally, by expanding and/or reducing the volume of the avatar, the surface thereof can be placed on the surface of the 3D scan. An “inside-out” test can be used to check how the avatar has to approach the 3D scan (in particular by expanding or reducing the circumference) in order to achieve a congruent overlap. In other words, the individual 3D body model data or 3D body shell data (3D scan data) can be projected onto the avatar, in particular with the help of the general skeletal data. As a result, the virtual surface of the virtual ideal avatar is preferably substantially congruent with the virtual surface of the original (captured) 3D scan, with holes and defects preferably being replaced by the ideal avatar. Thus, only a medium 3D scan quality with holes is advantageously the prerequisite for widely dealing with a large number of different 3D body scans in a uniform manner, or for ensuring a uniform and automated further processing of the data (by means of an algorithm). The process or the steps with which a superimposition and/or an (in particular substantially congruent) overlap of two data sets or of the virtual representations (in particular the virtual surfaces) of these data sets (e.g. a 3D scan data set and a virtual individual 3D body shell data set or avatar) is achieved or created is generally referred to as “projection” within the context of the present description.

A virtual, individual 3D garment is produced on the basis of the virtual 3D ideal design and the generated virtual individual 3D body model. In particular, this takes place in that the virtual 3D ideal design is projected onto the virtual 3D body model or onto the shell or surface of the virtual 3D body model. For the projection (also referred to as “transfer” or “mapping” in the context of this description), i.e. generally the “superimposition” of two data sets or the particularly congruent overlapping of the virtual representations or surfaces of these data sets (here the virtual 3D ideal design and the virtual 3D body model), analogous steps as also described in connection with the projection of a 3D scan data set and a virtual individual 3D body shell data set (avatars) can be carried out. In particular, anchor points or reference points (e.g. of a virtual skeleton) can be used. Alternatively or in addition, volume expansion and/or volume reduction of at least one of the two virtual representations can be carried out. Alternatively or in addition, an “inside-out” test can also be carried out.

According to the “virtual 3D ideal design”, which in particular represents design data with which an ideal garment to be produced can be represented virtually or graphically, a “virtual individual 3D garment” is understood to mean 3D garment data with which a 3D garment can be represented virtually or graphically. In particular, the “3D virtual individual garment” is represented by the 3D garment data. The “virtual individual 3D garment” or the 3D garment data is thus used in particular for the virtual representation of the individual garment to be made. In addition, the generated “virtual individual 3D garment” forms the basis for providing the at least one 2D cutting pattern. The “virtual individual 3D garment” thus comprises all information or data from the virtual individual 3D body model, which is necessary for a flattening or development or translation into a two-dimensional cutting pattern.

The at least one cutting pattern is finally generated by developing the virtual individual 3D garment. The terms “flattening/developing” here mean a mathematical conversion or scaling from a 3D representation to a 2D representation. The virtual individual 3D garment is flattened/developed by means of an algorithm based on at least one, in particular predefined or predetermined set of cutting rules. In particular, the flattening/development comprises the generation of one or more cuts or cutting lines on the basis of the at least one set of cutting rules.

The method preferably also comprises outputting the at least one cutting pattern or a cutting pattern selected therefrom, for example as a file, as a printout on paper or by direct data transmission to a cutting plotter and cutting a material using the cutting plotter. In particular, the method thus relates to producing an individual garment for a customer and correspondingly comprises the step of producing the garment.

With the aid of the method according to the invention, the garment to be individually made for a customer can be produced even more easily in comparison to conventional methods and can also be made more true to size. The present invention thus offers significant advantages over conventional methods for creating cutting patterns or producing clothing, particularly for customers whose body shape deviates from standard clothing sizes. Rather, known methods for the virtual flattening/development or segmentation of 3D surfaces are based on visual realism. This means that they are not realistic models in a physiological sense, but are based on a synthesized, virtual scenario on a representative, visual level. There, not real but virtually generated surfaces are assumed. The method according to the invention, however, is used to model genuine, real, physical bodies with the aid of the individual 3D body shell data or 3D scan data. In particular, with the aid of the method according to the invention, cutting lines for garments can be generated on the basis of the customer’s virtual body topology. The body-centered method for creating cutting patterns according to the present invention does not make any prior assumptions of analogous, conventional approaches and methods for cutting-pattern making. In particular, the method according to the invention offers transferability of the virtual flattening/development of cutting patterns to reality.

In comparison to the approach of classic 2D cutting pattern creation, in which a linear measurement of the three-dimensional body of the customer and a translation into standardized, in particular symmetrically mirrored 2D pattern standard size models takes place, customer-specific cutting patterns are created directly in 3D using a personal avatar according to the invention. These customer-specific 3D patterns are finally flattened/developed into 2D patterns to create the garment. In particular, it is possible within the scope of the present invention to algorithmically convert the determined 3D body shell data or the 3D scan into a physically moving, optionally also asymmetrical, avatar. The personal cutting patterns created in 3D can then advantageously be generated directly on the avatar (or an identical copy thereof).

A virtual reference model or topology model in the form of a (digital) ideal 3D body model can preferably be present or provided for creating the customer’s virtual individual 3D body model. A virtual skeleton with anchor points or node points can be fitted into this virtual ideal 3D body model. In other words, the virtual ideal 3D body model can be linked to the given general skeletal data. The canned 3D body shell data of the customer can be uploaded to a platform. In the backend, the determined 3D body shell data of the customer can also be linked to the specified general skeletal data, i.e. to a virtual skeleton having anchor points or nodes. The determined 3D body shell data can then be linked to the ideal virtual reference model using the skeletal data. In other words, the determined 3D body shell data can be transferred (projected or mapped) onto the ideal virtual reference model using the skeletal data. Here, the body proportions of the scan data can be taken over by the anchor points or node points and the reference model can be adapted to the customer data of the scanned 3D body model. In particular, the ideal reference model can be deformed (e.g. expanded or shrunk) until it is congruent with the customer’s 3D body shell data. The transfer of the customer’s 3D scan data to a deformed ideal reference model is helpful to ensure ideal further processing of the mesh model. The transfer can e.g. take place with the help of a neural network that has learned the transfer. Preferably, only the deformed ideal reference model - i.e. a created avatar of the customer - is used afterward.

In a preferred embodiment, a virtual individual 3D body model is created not only on the basis of the customer’s individually determined 3D body shell data and general skeletal data, but also on the basis of provided general 3D body shell data or a general 3D body model. Within the scope of this description, the general 3D body model is also referred to as a virtual reference model or topology model.

The “general 3D body shell data” is understood to mean 3D body shell data of an ideal reference model, which was obtained in particular on the basis of a standard avatar mesh. For example, the general 3D body shell data can be obtained from an ideal scan of a real or artificial model. In this context, the term “ideal” means in particular that an ideal reference model has a high or the highest possible quality (in particular no self-intersections or 2-manifold, no holes in the mesh surface, no motion errors and a uniform resolution of the mesh). In particular, the (ideal) scan data or (ideal) 3D body shell data obtained with an ideal reference model do not have any errors and/or defects or holes. In particular, the ideal scan data has a high or the highest possible precision of the 3D mesh (e.g. a triangulated surface). The “general 3D body shell data” of the virtual reference model is also such ideal data.

Like the individual 3D body shell data, the general 3D body shell data can also be linked or transmitted and/or mapped to the general skeletal data provided. In other words, the virtual skeleton can be integrated into the general 3D body shell data of the reference model. The general 3D body shell data together with the integrated virtual skeleton form a general 3D body model (reference model).

Preferably, both the individual 3D body shell data and the general 3D body shell data are respectively linked to the general skeletal data. It is thus advantageously possible to link or map the individual 3D body shell data with the general 3D body shell data via the common general skeletal data (in particular via the anchor points of the skeletal data). Errors, defects or holes in the determined individual 3D body shell data can be corrected by this link. In particular, a (virtual) modified individual 3D body model of the customer can be created by projecting the general ideal scan or the general 3D body shell data linked to the general skeletal data onto the individual 3D body shell data. This modified individual 3D body model and the associated modified avatar of the customer meets the requirements for further processing, in particular for algorithmic development. With the help of general 3D body shell data or a general 3D body model, a modified individual 3D body model of higher quality than the created individual 3D body model can thus be generated.

The use of general 3D body shell data or a general 3D body model to create a qualitatively high or superior modified individual 3D body model advantageously allows the determined individual 3D body shell data or individual scan data to have only a low or medium quality. This reduces the requirements for the scanning process, which can also be carried out using a standard smartphone or tablet.

In a further preferred embodiment, the virtual individual 3D garment is flattened/developed on the basis of a first and second set of cutting rules. In doing so, the first set of cutting rules takes into account specified or predetermined stylistic elements (in particular by the designer and/or customer). The second set of cutting rules takes into account specified or predetermined effect elements (in particular by the designer and/or customer). “Stylistic elements” are understood in particular to be so-called “add-ons” of an garment, such as puff sleeves, zippers, etc. “Effect elements” are understood in particular to be specific wishes of the designer or customer, such as broad shoulders, narrow waist, concealing the chest, etc. The first set of cutting rules is preferably applied before the second set of cutting rules.

In a further preferred embodiment, the virtual individual 3D garment is flattened/developed by successively applying the first set of cutting rules and the second set of cutting rules; in particular flattening/developing the virtual individual 3D garment also takes place on the basis of an automated flattening/development algorithm using a merit/target function (to be minimized).

Preferably, flattening/developing the virtual individual 3D garment comprises, in this order, generating one or more possible cuts or cutting lines on the basis of the first set of cutting rules, generating one or more possible cuts or cutting lines on the basis of the second set of cutting rules, and generating one or more possible cuts on the basis of an automated flattening/development algorithm. “Possible cuts” means that no cut, one cut or multiple cuts can be generated using the relevant set of cutting rules. The sets of cutting rules are preferably configured or defined such that as few cuts as possible are generated.

Within the scope of the invention, it has been found that using two sets of cutting rules, with a first set of cutting rules taking into account specified stylistic elements and a second set of cutting rules taking into account specified effect elements, developing or setting of cuts can be carried out particularly efficiently and in a material-saving manner, in particular if the first set of cutting rules is applied prior to the second set of cutting rules.

In a further preferred embodiment, flattening/developing the virtual individual 3D garment or the automated flattening/development algorithm comprises minimizing a merit/target function. Preferably, the merit/target function is minimized iteratively. More preferably, the merit/target function has one or more energy terms. In particular, the merit/target function comprises several energy terms that evaluate various aspects of the cutting pattern creation.

In another preferred embodiment, the merit/target function includes a strain energy term. Alternatively or in addition, the merit/target function comprises a length regularization energy term. Alternatively or in addition, the merit/target function comprises a voltage-energy term. The energy terms are preferably weighted, i.e. each provided with a weighting factor. The merit/target function E(p) can be represented mathematically in particular as follows:

$$E \left(p\right) = α {E}_{D} \left(p\right) + β {E}_{L} \left(p\right) + γ {E}_{S} \left(p\right) ,$$

where E_{D}(p) represents the strain energy term, EL(p) represents the length regularization energy term, E_{S}(p) represents the stress energy term, and α,β,γ>0 represent the weight factors associated with the respective energy terms. p denotes the set of all (current) cutting lines or cutting curves that are preferably aligned iteratively. In other words, the cutting lines are preferably optimized in an iterative process. A first initialization is assumed and the merit/target function is evaluated after each iteration step (e.g. with regard to achieving shorter cutting lines and/or less strain of the surface, etc.). The position of each cutting line is realigned (generatively) after each iteration or after each iteration step.

Doubly curved 3D surfaces can never be projected onto a 2D plane without strain (see e.g. world map). Existing development methods for bodies and objects offer different types of strain with advantages and disadvantages. For example, the so-called Mercator projection or Peters projection is known for the world map. In order to develop a method for cutting patterns, the strain must be kept as low as possible with the appropriate size of the pattern pieces. This is necessary to ensure processing without creases (e.g. transverse creases, random creases).

The degree of strain is described or evaluated with the strain energy term E_{D}(p). In particular,

$${E}_{D} \left(p\right) : = {\int }_{M} {u}^{2} d A$$

is the strain energy (stress), where u:=M ₚ → ℜ is the logarithmic strain factor of the conformal map and reflects the unitless Hencky strain. E_{D}(p) is chosen such that it sums up or integrates the strain factor or the strain energy over a surface M. Thus, by minimizing the strain energy term E_{D}(p), the strain can also be minimized.

The choice of fabric determines how much it can be stretched. It must therefore be ensured that the upper limit for the tension of the fabric is not exceeded. However, the lowest possible strain is generally desirable. Here, the merit/target function is minimized after each iteration step.

The length regularization energy term E_{L}(p) or its minimization ensures that the cutting edges do not become too long and at the same time smoothes the course of the cutting profile. By keeping the edges short, there are fewer (unnecessary) curves in the cut. This is necessary so that the production of the garment does not become too complicated (radius seam, practical assembly of pattern pieces). In this context, smoothing means that the lines are curved as little as possible (curved with a small radius). In particular,

$${E}_{L} \left(p\right) : = \frac{1}{2} {\int }_{p} d s ,$$

where ds is the arc length of the individual cutting curves. Smoothing can be accomplished by minimizing the energy term (curve shortening flow). Figuratively speaking, the same thing happens here as when tensioning a rope that was previously loose. Due to the tension of the rope, the rope sags less and the course line of the rope is smoother or straighter.

With E_{S}(p) or its minimization, it is ensured that the tension of all pattern pieces of a cutting edge is compatible with each other. In particular, with

$${E}_{S} \left(p\right) : = {\int }_{p} {\left({F}_{d i f f}\right)}^{2}$$

by means of the least squares method, the difference in the deformation gradients F_{diff} to the left and right of each cutting edge is determined or measured and is consequently minimized during the optimization. In particular, the deformation gradient is calculated along each cutting edge and minimized using the least squares method to the left and right of the cutting edge. The deformation gradient indicates how strongly something deforms locally at a point. The deformation substantially consists of stretching and rotation. If the stretching is small and the deformation is oriented in the same way (rotation in the same direction), then the deformation gradient is small as well. It follows that the seams on the left and right of the seam site are compatible with each other since the stretch/strain and rotation to the left and right of the seam site are small and approximately compatible with each other.

Furthermore, it is preferably ensured that the generated surface segments have a sufficiently straight edge. This can be done with the help of the one-dimensional special case of the mean curvature flow, the so-called curve shortening flow. With the help of the curve shortening flow, i.e. the mean curvature flow, the maximum curvature of the cutting curve can be minimized. As a result, the cutting curve is smoothed and the arc length of the cutting edge becomes smaller and smoother. Furthermore, the curve shortening flow and the measure introduced within the scope of the invention for determining the strain to the left and right of a fabric edge are also taken into account for the optimization.

During the generation of the cutting pattern, the course of the course of the cutting lines pₙ is optimized step-by-step, preferably based on E(pₙ₋₁), until the merit/target function E(p) falls below a limit value and a sufficient quality of the cutting pattern is thus achieved. Here, pₙ designates the set of all cutting lines in the n^{th} iteration step and accordingly pₙ₋₁ designates the set of all cutting lines in the (n-1)^{th} iteration step.

Prior to the initialization and iterative minimization of the merit/target function, certain upper limits (in particular for the strain and/or for the size of the pattern pieces to be produced) and/or a style can be specified.

By setting an upper limit for the strain and by the style chosen by the user, the user can influence the weighting of the various optimization terms. Textiles have different levels of stretch. In addition, different styles are possible. Thus, the first initialization can have different goals. For example, a so-called “zero waste” cutting pattern (without fabric waste/waste material) aims to create patches that are as small and even as possible (similar to a soccer ball pattern). To achieve this, e.g. the length regularization is weighted higher than the strain energy. This results in shorter and smoother cutting edges.

The selection of an upper limit for the size (length and width) of the pattern pieces to be produced does not have any aesthetic purpose, but only serves to ensure that the garment can actually be manufactured. Typically, rolls of fabric have a width of 1.20 m - 1.40 m, which is a limiting factor. Therefore, the optimization term respects this upper limit and ensures that this upper limit is observed through a re-weighting. As soon as the upper limit is exceeded (e.g. because the edge along the short side is larger than the width of the panel of fabric), then a new cutting edge must be inserted. After enough cutting edges have been inserted to ensure that the garment can actually be manufactured with regard to the specified roll of fabric (i.e. if the set upper limit is observed), the initialization for the iterative minimization of the merit/target function can be carried out on the basis of all inserted cutting edges.

In a further preferred embodiment, a virtual individual 3D garment is created or a virtual 3D ideal design is provided on the basis of user specifications. In particular, creating a virtual individual 3D garment or the provision of a virtual 3D ideal design comprises selecting from a specified clothing catalogue, a specified style element catalogue, a specified effect element catalogue, and/or a specified material catalogue. The selection can take place in the form of user input, for example.

In a further preferred embodiment, creating a virtual individual 3D garment comprises the step of:
-- enlarging the volume of the virtual individual 3D body model or avatar (in particular an identical copy thereof) depending on the type of clothing and/or depending on a selected material and/or depending on a simulated movement (or depending on different simulated poses) of the virtual individual 3D body model.

In particular, different poses or body positions of the virtual individual 3D body model (avatar) and/or a movement of the virtual individual 3D body model can be simulated on the basis of the determined 3D body shell data (3D scan). In particular, different poses or body positions of the virtual individual 3D body model (avatar) and/or a movement of the virtual individual 3D body model can be simulated on the basis of the determined 3D body shell data (3D scan). On the basis of such a simulation, e.g. disturbing stretching, disturbing tension and/or disturbing creases of the individual 3D garment, which occur due to a certain movement and/or pose of the customer, can be recognized or determined. The virtual, individual 3D body model provides the basis for creating the virtual, individual 3D garment. For example, the virtual individual 3D garment can be created by making a copy of the 3D body model and processing it the sense of a virtual customization based on the ideal 3D virtual design. In particular, a texture simulation of a textile (fabric simulation) in the form of physical elastic modulus values (i.e. values that indicate e.g. the stretchability and/or rigidity of a textile) can be superimposed on the virtual individual 3D garment, i.e. the 3D garment data can be supplemented by such modulus of elasticity values. Stretching and tensions in the garment can be simulated from a combination of physical elasticity modulus values of the textile and movement sequences of the 3D body model. Such stretching and tensions for the garment to be made or the cutting pattern to be made are preferably taken into account in the form of freedom of movement between the virtual individual 3D body model and the virtual individual 3D garment. For example, a deformation of the 3D body model data (or the copy thereof) can be caused on the basis of a targeted, user-adapted movement. This virtual deformation can e.g. be a basis for considering or creating freedom of movement in reality. The virtual deformation can be incorporated into the 3D garment data (e.g. as a copy). In other words, virtual deformation data can be added to the 3D garment data.

In particular, certain distances between the garment and the customer’s body can be dynamically determined by a virtual movement (or movement simulation) of the arms, the torso and/or the legs, etc. It is thus advantageously possible to ensure an individually desired freedom of movement for the customer and consequently to optimize the wearing comfort of the individual garment to be made for the customer. In particular, a predetermined, predeterminable or selectable (i.e. desired) range of motion of the avatar or a real person (customer) can be realized in this way. In other words, movements of the avatar or of a real person (customer) that are predetermined, predeterminable or selectable (i.e. desired) while wearing the individual garment to be made can be made possible.

In order to increase the accuracy of a movement simulation of the virtual individual 3D body model, determining 3D body shell data of the customer can comprise determining 3D body shell data of the customer in different poses (e.g. hanging arms, arms stretched up, arms stretched to the side, forwards stretched arms, bent arms, lifted foot, etc.) of the customer. In principle, however, it is possible to determine the customer’s 3D body shell data for only one pose (e.g. a predefined or selected standard pose) and to simulate at least one other pose and/or a movement of the customer’s virtual individual 3D body model (avatar) on a computer-based manner or using an algorithm. To simulate at least further poses and/or a movement of the avatar on the basis of the customer’s 3D body shell data, it is possible to use known computer-implemented methods, e.g. based on a deformation transfer (see e.g. Robert W. Sumner and Jovan Popovic: “Deformation transfer for triangle meshes”, ACM Transactions on Graphics, August 2004, pages 399-405, DOI: https://doi.org/10.1145/1015706.1015736), a “Poission shape interpolation” (see e.g. Dong Xu et al: “Poisson shape interpolation”, Graphical Models, volume 68, issue 3, 2006, pages 268-281, ISSN 1524-0703, https://doi.org/10.1016/j.gmod.2006.03.001), and/or other suitable interpolation algorithms.

The volume of the individual 3D body model or an (identical) copy thereof can be enlarged. The modified or enlarged individual 3D body model or the copy thereof can then be adjusted using the 3D ideal design. The result is in particular the virtual 3D garment, which can finally be broken down into a 2D pattern through flattening/development and an optional production adjustment. Additional cutting lines can be generated where appropriate.

In another preferred embodiment, creating a virtual individual 3D garment further comprises the step of:
-- projecting the virtual 3D ideal design onto the shell or surface of the enlarged virtual individual 3D body model or avatar.

The virtual 3D ideal design can be projected or transferred or mapped onto the avatar in particular via the anchor points or nodes of the avatar. In particular, the 3D virtual ideal design can first be registered with the (enlarged) 3D virtual individual body model (i.e. the 3D virtual ideal design and the 3D virtual individual body model are locally superimposed), so that the location and orientation of the 3D virtual ideal design and the virtual individual 3D body model are substantially identical in space.

In a further preferred embodiment, at least one final virtual 3D garment is generated and displayed on the basis of the at least one cutting pattern created. The final virtual 3D garment can be displayed e.g. on a display using virtual reality or on the real body using augmented reality. In other words, the at least one two-dimensional cutting pattern created is reassembled into a virtual 3D object (namely the final virtual garment).

In a further preferred embodiment, the method further comprises determining at least one linear dimension and/or at least one body circumference of the customer on the basis of the determined individual 3D body shell data.

In a further preferred embodiment, the method further comprises comparing the at least one linear measure and/or body circumference of the customer determined on the basis of the individual 3D body shell data with at least one standard cutting pattern (or a conventional cutting pattern) and/or with at least one predetermined one measurement chart (e.g. women’s outerwear measurement chart). Such a comparison makes it e.g. possible for an existing virtual design, which is usually only tailored to (small) standard sizes, and/or an existing 2D cutting pattern or standard cutting pattern to be adapted and to be expanded to a virtual 3D ideal design. In particular, an already existing virtual design and/or 2D cutting pattern can be converted into a parametric 3D model using such a comparison. To this end, it is helpful if the individual 3D body shell data is associated or compared with known (conventional) industry data, in particular using standard dimensions and/or size charts (specified by the industry or manufacturers).

A further independent aspect for solving the object relates to a computer program product comprising machine-readable program code which, when loaded on a computer, is suitable for carrying out the method according to the invention described above. In particular, a computer program product is understood to be a program stored on a data carrier. In particular, the program code is stored on a data carrier. In other words, the computer program product comprises computer-readable instructions which, when loaded into a memory of a computer and executed by the computer, cause the computer to perform an inventive method as described above. The invention thus provides a computer program product, in particular in the form of a storage medium or a data stream, which includes program code which, when loaded and executed on a computer, is configured to carry out a method according to the present invention, in particular in a preferred embodiment.

A further independent aspect for solving the object relates to a device (cutting pattern creation device) for providing at least one cutting pattern of a garment to be made individually for a customer, comprising:
a processor or a calculation module executed by a processor, which is configured to:
   -- create a virtual 3D body model of the customer on the basis of individually determined 3D body shell data of the customer and given general skeletal data,
   -- create a virtual individual 3D garment on the basis of a virtual 3D ideal design and the virtual 3D body model, and
   -- create the at least one cutting pattern by flattening/developing the virtual individual 3D garment, wherein flattening/developing the virtual individual 3D garment takes place algorithmically on the basis of at least one set of cutting rules.

In particular, the device can further comprise a data provision module, which is configured to:
-- provide the general skeletal data, in particular in a memory, and/or
-- provide the virtual 3D ideal design of the garment to be made, in particular in a memory.

Alternatively or in addition, the device can comprise a data acquisition module, which is configured to acquire the customer’s individual 3D body shell data.

Furthermore, the device can comprise cutting means or a cutting plotter for outputting the at least one cutting pattern. Outputting the at least one cutting pattern is understood to mean, in particular, cutting a material or fabric to size.

The present invention also offers the further aspects, features, embodiments and advantages described below.

In a further preferred embodiment, the method described above also comprises the step of:
storing the created virtual individual 3D body model of the customer in an avatar comparison database, the avatar comparison database providing a large number of virtual individual 3D body models from different customers in order to compare or match these provided virtual individual 3D body models with one another.

Preferably, the avatar comparison database already comprises a large number of virtual, individual 3D body models from other customers. In particular, the comparison takes place with the aid of a computer or processor. In particular, the comparison or matching takes place with the aid of an avatar comparison device or an avatar matching device. Any methods or algorithms known from the prior art, in particular for feature analysis or feature recognition, can be used for the comparison or matching. This makes it possible, for example, to find virtual individual 3D body models with similar or identical properties that are stored in or provided by the avatar comparison database. Advantageously, the “second hand” fashion segment can thus also be served. For example, it may be the case that a customer for whom an individual garment was produced on the basis of the cutting pattern provided according to the invention wants to sell this garment again at some point. The avatar of this customer can then be compared and/or matched with at least one avatar of another customer (preferably several avatars of other customers) with the aid of the avatar comparison database. In other words, at least one avatar from another customer (preferably several avatars from other customers) having similarities with the avatar of the customer who wants to sell his individual garment again can be searched for or found in the avatar comparison database. For example, on the basis of such a comparison or found matches, the (used) garment can automatically be offered for sale to another customer (in particular a matched customer, i.e. a customer who substantially fits the garment). In particular, recommendations can be made as to which second-hand clothing for sale fits which customer. This means that size matching can also be guaranteed in the second-hand fashion segment.

In a further preferred embodiment, the method further comprises the step of:
comparing the customer’s created virtual individual 3D body model to other 3D virtual custom body models provided by the avatar comparison database.

Preferably, the method (and in particular the step of comparing mentioned above) comprises matching the customer’s created virtual individual 3D body model with at least one other virtual individual 3D body model provided by the avatar comparison database. If such a “match” is found, e.g. a note or a recommendation as to which customers with regard to their body characteristics and thus with regard to garments individually made for them match can be stored in the database or the memory and/or output with an output unit (e.g. monitor or printer).

In a further preferred embodiment, the method further comprises the step of:
assigning the customer’s created virtual individual 3D body model to at least one avatar group from a large number of predetermined avatar groups.

The different avatar groups are preferably each characterized or predetermined by certain body characteristics, in particular body dimensions and/or body peculiarities (such as a certain posture, a certain body irregularity and/or a certain body deformity). As already mentioned, the method can comprise comparing or matching the customer’s created virtual individual 3D body model with at least one other virtual individual 3D body model provided by the avatar comparison database. In other words, at least one further virtual individual 3D body model provided by the avatar comparison database can be searched for or found, which is similar to the customer’s created virtual individual 3D body model (in particular with regard to certain body characteristics) or matches the customer’s created virtual individual 3D body model (in particular with regard to certain body characteristics).

Accordingly, in a further preferred embodiment, the device described above can further comprise:
an avatar comparison database for storing the customer’s created virtual custom 3D body model, the avatar comparison database providing a large number of virtual custom 3D body models from different customers to compare the provided virtual custom 3D body models with one another.

The avatar comparison database can be provided in particular by a memory or by a storage medium of the device. However, it is also possible to provide the database by an external server or a cloud.

In a further preferred embodiment, the device further comprises:
an avatar comparison device or an avatar matching device for comparing the customer’s created virtual individual 3D body model with other virtual individual 3D body models provided by the avatar comparison database.

In particular, the avatar comparison device or avatar matching device is configured to match the customer’s created virtual individual 3D body model with at least one other virtual individual 3D body model provided by the avatar comparison database. Furthermore, the avatar comparison device or avatar matching device can be configured to assign the customer’s created virtual individual 3D body model to at least one avatar group from a large number of predefined avatar groups. The avatar comparison device or avatar matching device can be part of a computer and/or the processor of the device, for example.

The statements made above or below regarding the embodiments of the first aspect also apply to the above-mentioned further independent aspects and in particular to preferred embodiments in this regard. In particular, the statements made above and below regarding the embodiments of the respective other independent aspects also apply to an independent aspect of the present invention and to related preferred embodiments.

In the following, individual embodiments for solving the object are described by way of example on the basis of figures. Here, some of the individual embodiments described have features that are not absolutely necessary to implement the claimed subject matter, but which provide desired properties in certain applications. Thus, embodiments that do not including all the features of the embodiments described below should also be considered to be covered by the technical teaching described. Furthermore, in order to avoid unnecessary repetition, certain features are only mentioned in relation to individual embodiments described below. It is pointed out that the individual embodiments should therefore not only be considered individually, but should also be viewed in combination. Based on this combination, the skilled person will recognize that individual embodiments can also be modified by incorporating individual or multiple features of other embodiments. It is pointed out that a systematic combination of the individual embodiments with individual or several features described with regard to other embodiments can be desirable and useful and should therefore be taken into consideration and also be regarded as covered by the description.

### BRIEF DESCRIPTION OF THE DRAWINGS

FIG. 1 shows a schematic flowchart of the method according to a preferred embodiment of the present invention;

FIG. 2 shows a schematic flowchart of the flattening/development process of the virtual individual garment from 3D to 2D according to a preferred embodiment of the present invention;

FIG. 3 shows a schematic flowchart of the displaying and outputting of the created cutting pattern according to a preferred embodiment of the present invention;

FIG. 4 shows a schematic drawing of an exemplary virtual skeleton with fixed points in a front view (left) and rear view (right);

FIG. 5 shows a schematic image of the generation of a high-quality virtual 3D body model.

### DETAILED DESCRIPTION OF THE DRAWINGS

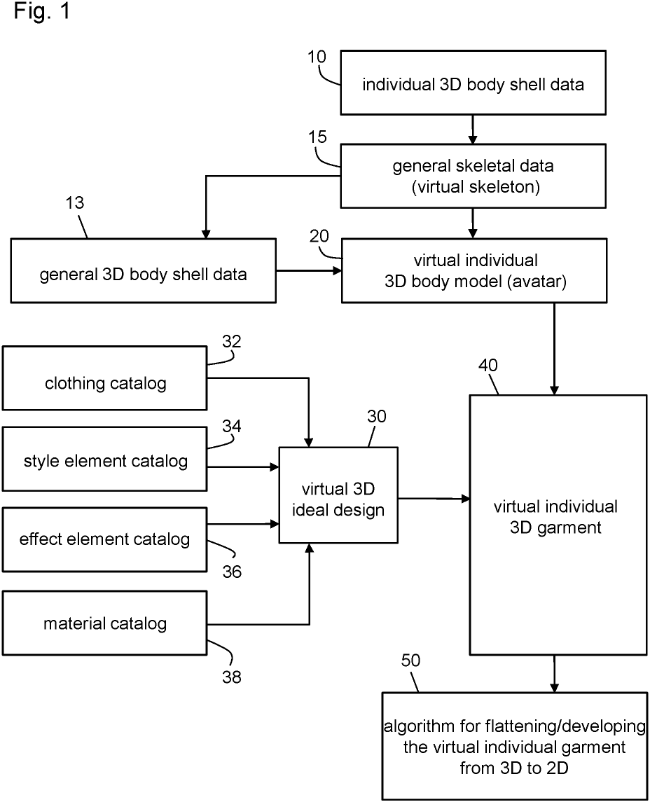

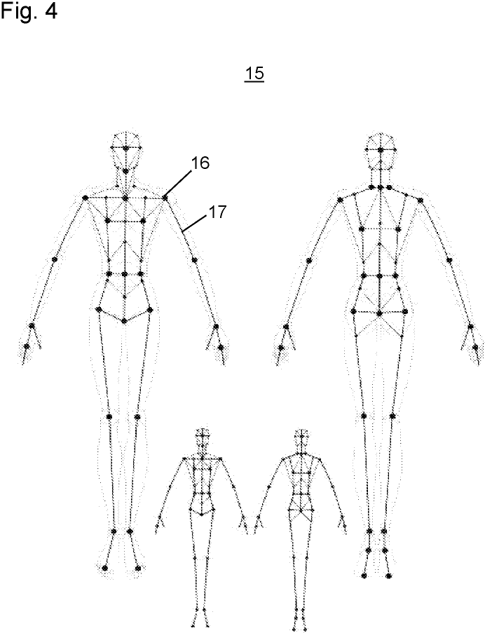

FIG. 1 shows a flowchart of the sequence of the method according to a preferred embodiment of the present invention. First, individual 3D body shell data 10 of a real person (customer) is generated, e.g. with a smartphone or tablet via an app. This is a scanning process, so that the 3D body shell data comprises or is scan data or 3D mesh data. The scanning process can be carried out in low quality. The individual 3D body shell data is linked to general skeletal data provided or predefined or to a virtual skeleton 15 (see FIG. 4). On the basis of the customer’s individually determined 3D body shell data 10 and the general skeletal data 15 provided, a virtual individual 3D body model or an avatar 20 of the customer is finally created.

In addition, general 3D body shell data (or model data) 13 can be provided by a general ideal scan, in particular of a model, which is also linked to the general skeletal data 15 in order to create or provide a general perfect 3D body model in this way. The quality of the virtual individual 3D body model can be increased by linking the general perfect 3D body model provided to the virtual individual 3D body model created by the 3D scan. By such linking or projection defects or holes in the 3D mesh can be corrected. In other words, a high-quality virtual individual 3D body model 20 can be created on the basis of the determined individual 3D body shell data 10, the provided general skeletal data 15 and the provided general 3D body shell data.

It is pointed that some of the lines or arrows shown in the flowchart in FIG. 1 are only intended to indicate a link between two data sets (and not necessarily a “calculation direction”). For example, the data set 10 and the data set 15 can be linked to create the data set 20. In addition, the data sets 15 and 13 can be linked to one another in order finally to increase the quality of the data set 20 (i.e. the quality of the virtual individual 3D body model) by linking it to the data set 20 obtained from the data sets 10 and 15.

The customer’s scan can be available e.g. as a 3D surface mesh model in medium scan quality (with occasional holes in the scan). The virtual skeleton including nodes (joints) and connecting elements (bones) is placed into this scan. The placement of the skeleton can be done via a neural network. In parallel, there can be a perfect base mesh (i.e. a model topology, which in particular comprises the model data and the general skeletal data or a combination and/or linking or convolution thereof), which includes a virtual skeleton with exactly the same nodes and connecting elements. After all nodes and/or connecting elements have been identified with each other, the scan skeleton (i.e. the virtual individual 3D body model) is placed on the perfect base mesh (i.e. the virtual individual 3D body model is mapped with the perfect base mesh or matched) and the base mesh is adapted to the proportions of the 3D body scan by the scan skeleton or its nodes (through surface deformation in all mesh areas that are close to the affected skeleton nodes). This allows working with a closed mesh model in the further course, which does not have any defects or holes. The “mapping” or “matching” of the virtual individual 3D body model with the perfect base mesh comprises or is in particular a “mesh registration”. The 3D body model (avatar) can be edited with regard to size, physique, shape, posture and even dynamic (motion) properties by means of an editable set of input parameters.

A virtual ideal 3D design 30 is created or provided to create a virtual individual 3D garment 40. This virtual 3D ideal design can be based on the specifications of the designer and/or the customer from a clothing catalog 32, a style element catalog 34, an effect element catalog 36, and/or a material catalog 38. From the clothing catalog 32, the type of clothing (e.g. jacket, trousers, sweater, etc.) can be selected. Style elements such as puffed sleeves or a zipper can be selected from the style element catalog 34. Certain effect elements such as broad shoulders, narrow waist, conceal breast, etc. can be selected from the effect element catalog 36. Also, the material of the garment to be made (e.g. jeans, poplin, jersey, etc.) can be selected from the material catalogue.

Style elements comprise in particular so-called “add-ons” that are placed on the basic garment, e.g. widening of the skirt plate, insertion of puffed sleeves on the T-shirt, waterfall collar on the blouse, colored folds on the trousers, shape of the trousers (“carrot shape”, “slim fit”, “high waist”, “⅞ length”, “flares”). There are also zippers, buttons, Velcro fasteners or elastic bands to choose from as additional style elements.

Effect elements are personal preferences of the designer or customer, which emphasize or cover up parts of the body. In a query selection, the customer can e.g. indicate whether they have narrow shoulders and would like to visually broaden them, have large breasts and would like to conceal them optically, have a narrow waist and would like to emphasize it.

Before the created avatar 20 appears in the front end, a semantic mesh segmentation and proportional increase in volume of the avatar 20 take place in the back end. This is not visible in the frontend. A function that functionally models the edge of the volume in dependence is placed for each body segment parallel to the axis of rotation of the body part. In particular, distances to the surface, which vary depending on the body part, are provided by means of a signed distance function. The specifically selected distance depends in particular on the location, the type of textile and/or the style of the garment. The 3D body model (avatar) can be edited with regard to size, physique, shape, posture and even dynamic (motion) properties by means of an editable set of input parameters. This means that movement distances of the individual limbs produce different movement radii and therefore different distances (for freedom of movement or support function for body parts that are to be emphasized). For example, more distance can be calculated on the upper arm than on the forearm, or a narrower circumference on the waist in order to emphasize it. For example, in the case of an elbow, the circumferential distance is greater than the distance to the forearm, or the circumferential distance to the armpit area is greater than the distance to the upper arm. This ensures a certain freedom of movement. Different limbs require different freedoms of movement or have different angles of rotation and require different degrees of freedom. This results in different distances from the body shell to the garment.

In the frontend, a virtual ideal draft of the basic garment is projected onto the virtual (frontend) avatar (without any visible increase in volume). Within the context of the invention, “front end” is understood to mean in particular a mobile application (app) or a website (or a portal) that is available to the user (customer, end consumer, designer or tailor) as a graphical user interface. In the frontend, the customer can see information and act themselves. “Backend” means internal processes the customer does not see within the application or website and with which he cannot interact. In particular, “backend” means a part of an IT system that deals with data processing in the background (i.e. the “data layer”). The term “backend” can therefore comprise e.g. calculation and optimization software, which is preferably stored on a server and which executes the necessary calculations or algorithms (in the background).

Style elements and/or effect elements are selected in the frontend. In the backend, the implementation of the added “add-ons” means a regional deformation of the surface of the backend avatar. For example, for a puff sleeve t-shirt, a sphere is modeled onto the shoulder of the backend avatar, with faithfully replicates the volume of the puff sleeve. For example, a skirt has a sleeve connected to the outside of the legs wrapped around the legs. In the backend, the rest of the body is cut off, especially at the level of the skirt length (in this case the legs) and at the level of the skirt waistband, so that the skirt body can be developed. In the case of a fitted blouse with a flared hip, for example, a cone is modeled on the side of the hip. In addition, a minimum and maximum parameterization can be stored algorithmically, i.e. if the cross-section of a sleeve falls below the radius of a hand, suggestions are made to use a zipper or a slit so that the garment can be put on. In the case of a neckline, for example, the head circumference is calculated from the scan to ensure that the garment can be put on. If this radius is not reached, suggestions are automatically made as to whether a zipper or slit or something else should be used. A similar procedure is used for a skirt or dress, for example. Here, in particular the pelvis and shoulder circumference are measured. In the backend, the effect elements - e.g. based on a query of body parts that are to be emphasized or concealed - are translated in particular into the number and main orientation of the cutting lines. For example, in the case of large breasts that need to be covered, the pattern parts in the segment of the breast area can be arranged in small parts, i.e. more cutting lines than necessary can be set. In the case of narrow shoulders that should appear wider, cutting lines can be oriented perpendicular to the body axis (90 degrees). When a narrow waist is to be emphasized, the body shape in the abdominal segment can be oriented lengthwise to the body axis.

As can be seen from FIG. 1, the virtual individual 3D garment 40 is generated on the basis of the virtual 3D ideal design 30 and the generated virtual individual 3D body model 20. In particular, the ideal virtual design 30 of the garment is projected onto the avatar 20. A specified distance from the body must be maintained in order to ensure the desired freedom of movement. This distance results in particular from the material to be used and the type of garment. A distance of 1 cm from the body is usually sufficient for tight-fitting clothing or clothing made of stretch fabrics. A circumferential distance of 2 cm is suitable for loose-fitting clothing, for example. Technically, this is solved in particular by increasing the volume of the avatar 20.

After the virtual individual 3D garment 40 has been generated, the virtual individual 3D garment 40 is flattening/developed from 3D to 2D with the aid of an algorithm 50, i.e. the virtual individual three-dimensional garment 40 is projected onto a two-dimensional plane.

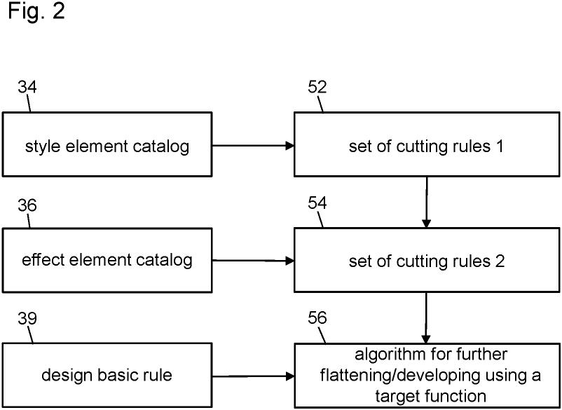

FIG. 2 shows a schematic flowchart of the flattening/development process of the virtual individual garment 40 from 3D to 2D according to a preferred embodiment. As can be seen from FIG. 2, the virtual individual 3D garment 40 is flattened/developed in particular on the basis of a first set of cutting rules 52 and a second set of cutting rules 54. One or more first cuts are defined via the style element catalog 34. For example, cutting lines for zippers etc. can be inserted. Further cuts are defined via effect elements selected by the designer and/or user from the effect element catalog 36, e.g. for a narrow waist etc. Further cut lines are set in particular via an algorithm using a merit/target function to be minimized. A basic design rule is preferably taken into account, which states that numerous cutting lines are to be avoided or hidden as far as possible. Instead, as few cutting lines as possible and cutting lines as clear as possible should be set.

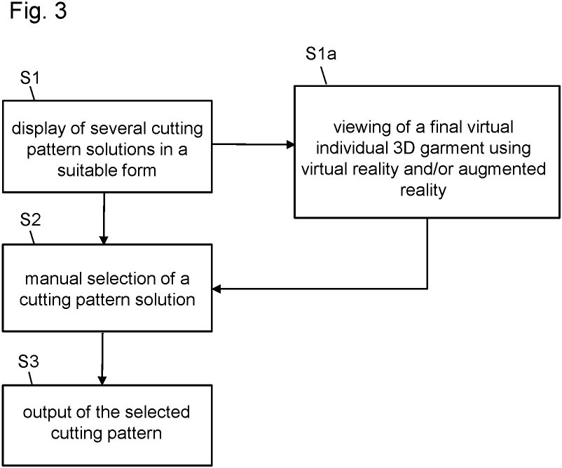

FIG. 3 shows a schematic flowchart of the displaying and outputting of the created cutting pattern according to a preferred embodiment. According to a step S1, several cutting pattern solutions, i.e. several possible cutting patterns, from which a user can choose are output or displayed. To this end, an associated final virtual individual 3D garment can be created for each possible pattern, which can be viewed on the avatar via virtual reality and/or on the real body of the customer via augmented reality (step S1a). According to a step S2, a cutting pattern solution is selected from the displayed patterns or final virtual individual 3D garments. The selected cutting pattern can then be output in a step S3, e.g. as a PDF file, as a printout on paper or via direct transfer to a cutting plotter on fabric (as a real cut or via augmented reality).

FIG. 4 shows a schematic drawing of an exemplary virtual skeleton 15 with fixed or anchor points 16 (which represent joints in particular) and connecting lines 17 (which represent bones in particular). A front side of the virtual skeleton 15 is shown on the left side of FIG. 4 and a back side of the virtual skeleton 15 is shown on the right side of FIG. 4. The anchor points 16 and connecting lines 17 and their relative arrangement in space (coordinates) form the general skeletal data. In the two outer large representations of FIG. 4, the shell of the human body is indicated in each case. The two middle, smaller representations of FIG. 4 each only show the virtual skeleton without a body shell.

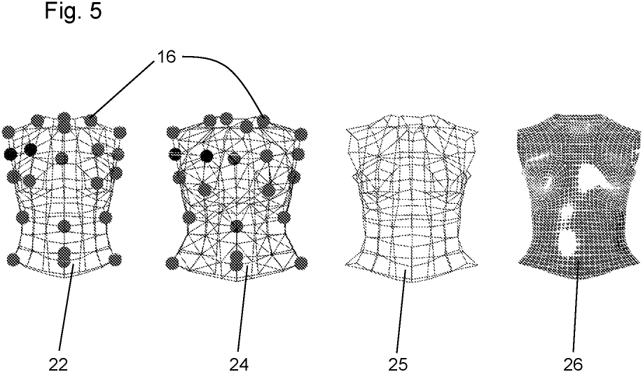

FIG. 5 shows a schematic image for creating a high-quality virtual 3D body model 26. 3D scans of people can be taken using a mobile phone app. In this case, body scan data 24 of medium to poor quality are sufficient. The scan 24 is then mapped or projected onto an ideal reference model or a topology model 22 (fixed points that can be easily read from the scans, such as shoulders, breasts, buttocks, etc.). To this end, topology fixed points 16 of a virtual skeleton 15 (see FIG. 4) are mapped with the 3D body scan 24 of low or medium quality. These topology fixed points 16 are linked to corresponding or associated topology fixed points 16 of the topology model 22, and a digitally perfect 3D mesh body model 26 of the scanned body (of the customer) is created thereby. In particular, the topology model 22 is deformed during projection or mapping in order to adapt it to the size of the 3D scan 24. A topology model 25 adapted to the 3D scan 24 and thus deformed is also shown in FIG. 5 as an example. Digital fashion designs that are also provided with fixed or reference points 16 can subsequently be imaged or projected onto the perfect 3D mesh body model 18. A cutting pattern can then be generated on the basis of at least one set of cutting line rules.

The set of cutting line rules leads to the creation of cutting patterns advantageously generated for the person. Depending on the body shape, the cuts are placed on other parts of the body. This setting of cutting lines arises from the topology of the respective body scan and is created by the algorithmic segmentation (dissection) and development of doubly curved (three-dimensional) surfaces with low, optimized angular distortions. The approach of segmenting curved surfaces (into multiple patches by means of cutting lines) is in particular a component of the present method in order to create planar surfaces from doubly curved surfaces and to map structures that can be produced from flat materials, such as paper or textiles. It is mathematically and therefore technologically impossible to map doubly curved surfaces exactly and without distortion in two dimensions, or only in an approximation or optimization process. In the method described here, the doubly curved surfaces cannot only be evaluated based on their characteristics (curvature and length of the curves). The projection of the segments onto a planar (flat) plane provides distortions or warping, which the applied cutting curves are supposed to imply. Specifically, this means that cutting lines are set automatically in those places where, from a purely technological point of view, the 3D surfaces cannot be flattened/developed into 2D because this would lead to warping or overlapping of fabric webs. These cutting lines created from the topology also result in the best possible fit for the garment to be made and guarantee the least amount of creases in the garment after the fabric has been sewn together, because they represent the most curved points (high-low points) of the body. The segmentation can be done according to various criteria as an initialization for the algorithm. For example, one criterion can be that contiguous round areas are to be clustered so that the number of residual areas (waste) is as small as possible. Another conceivable criterion is to create horizontal or vertical surfaces that are as continuous as possible, in order to emphasize body proportions or make them appear narrower. An initialization of small “patches” (pattern parts) is also possible, in order to make a large bust size appear smaller in the chest area, for example.

In summary, the present invention comprises a new method for the true-to-size and individual production of cutting patterns with the help of an algorithm based on 3D body scans. In particular, starting from a 3D body scan, a topology with many different fixed points of the body is generated, onto which a design is projected. The resulting projection is scaled (developed) from a 3D representation to a 2D representation to create useful pieces of fabric. In particular, darts and cutting patterns are automatically created by the algorithm. With the help of the present invention, individual or personalized unique cutting patterns can be generated. In particular, the invention distinguishes itself from conventional methods or systems in that it simplifies the production of cutting patterns and at the same time makes the garments even more true to size or individually adapted and also more cost-effective.

In contrast to conventional methods, in which an existing 2D cutting pattern (standard cutting pattern) is always used to produce garments and is adapted, where applicable, on the basis of the customer’s individual scan data, the present invention can be used to directly create an individual cutting pattern based on 3D body shell data or based on scan data. An existing 2D standard cutting pattern is therefore no longer required. While previous methods are based on a two-dimensional “basic pattern”, which is based e.g. on symmetrical pattern parts that can be mirrored, the method according to the invention can be used in particular to take into account the topology of an individual 3D scan of the customer’s body in order to individually divide the body surfaces of the customer into segments that can be flattened/developed two-dimensionally. In this way, an individual cutting pattern can be created, which can also produce non-symmetrical patterns. The present invention thus makes it possible to take into account individual body characteristics of the customer (such as a hunchback, deformities, a shorter arm or leg, disabilities, etc.) for the production of garments.

List of reference numerals

| | |
|---|---|
| 10 | individual 3D body shell data (scan data) |
| 13 | general 3D body shell data (model data) |
| 15 | general skeletal data (virtual skeleton) |
| 16 | nodes (anchor point) |
| 17 | connecting element |
| 20 | virtual individual 3D body model (customer’s avatar) |
| 22 | model topology (3D virtual general 3D body model) |
| 24 | scanned model (virtual individual 3D body model or avatar) |
| 25 | adapted or deformed model topology |
| 26 | refined topology (high quality avatar of the customer) |
| 30 | virtual 3D ideal design of the garment to be made |
| 32 | clothing catalogue |
| 34 | catalog of style elements |
| 36 | catalog of effect elements |
| 38 | catalog of Materials |
| 39 | design basic rule |
| 40 | virtual individual 3D garment |
| 50 | flattening/development algorithm |
| 52 | first set of cutting rules |
| 54 | second set of cutting rules |
| 56 | algorithm for further development using a merit/target function |
| S1 | display of several cutting pattern solutions in a suitable form |
| S1a | viewing of a final virtual 3D garment using virtual reality and/or augmented reality |
| S2 | manual selection of a cutting pattern solution |
| S3 | output of the selected cutting pattern |

1. A method for providing at least one cutting pattern of a garment to be made individually for a customer, comprising the steps of:
creating a virtual individual 3D body model of the customer based on individually determined 3D body shell data of the customer and provided general skeletal data;
creating a virtual individual 3D garment based on a virtual 3D ideal design and the created virtual individual 3D body model; and
creating the at least one cutting pattern by flattening/developing the virtual individual 3D garment, wherein flattening/developing the virtual individual 3D garment comprises, in this order, generating one or more possible cuts on the basis of a first set of cutting rules, generating one or more possible cuts on the basis of a second set of cutting rules, and generating one or more possible cuts on the basis of an automated flattening/development algorithm, the first set of cutting rules taking into account specified style elements of the garment and the second set of cutting rules taking into account specified effect elements of the garment.

2. The method according to claim 1, wherein creating a virtual individual 3D body model further takes place on the basis of provided general 3D body shell data.

3. (canceled)

4. (canceled)

5. The method according to claim 1, wherein generating one or more possible cuts takes place on the basis of an automated flattening/development algorithm using a merit/target function to be minimized.

6. The method according to claim 1,
wherein flattening/developing the virtual custom 3D garment comprises minimizing a merit/target function, and
wherein the merit/target function comprises a distortion energy term and/or a length regularization energy term and/or a strain energy term.

7. The method according to claim 6, wherein the merit/target function is defined by the equation E(p) = αE_{D}(p) + βE_{L}(p) + γE_{S}(p), where E_{D}(p) represents the distortion energy term, E_{L}(p) the length regularization energy term, E_{D}(p) the strain energy term, and α, β, γ > 0 represent weight factors associated with the respective energy terms.

8. The method according to claim 1, wherein creating a virtual individual 3D garment takes place on the basis of user specifications and in particular a selection from a predetermined clothing catalog, a predetermined style element catalog, a predetermined effect element catalog and/or a predetermined material catalog.

9. The method according to claim 1, wherein creating a virtual custom 3D garment comprises:
enlarging the a volume of the virtual individual 3D body model to form an enlarged virtual individual 3D body model depending on the type of clothing and/or depending on a selected material and/or depending on a simulated movement of the virtual individual 3D body model.

10. The method according to claim 9, wherein creating a virtual custom 3D garment further comprises:
projecting the virtual 3D ideal design onto a shell of the enlarged virtual individual 3D body model.

11. The method according to claim 1, wherein at least one final virtual individual 3D garment is created and displayed on the basis of the at least one created cutting pattern.

12. The method according to claim 1, further comprising:
determining at least one linear measurement and/or at least one body circumference of the customer on the basis of the determined individual 3D body shell data.

13. The method of claim 12, further comprising:
comparing the at least one linear measurement and/or body circumference of the customer on the basis of the determined individual 3D body shell data with at least one standard cutting pattern and/or with at least one predetermined measurement chart.

14. The method according to claim 1, further comprising:
storing the created virtual individual 3D body model of the customer in an avatar comparison database, the avatar comparison database providing a large number of virtual individual 3D body models from different customers in order to compare or match these provided virtual individual 3D body models with one another.

15. The method of claim 14, further comprising:
comparing the created virtual individual 3D body model of the customer to other virtual custom 3D body models provided by the avatar comparison database.

16. The method according to claim 14, further comprising:
assigning the created virtual individual 3D body model of the customer to at least one avatar group from a large number of predefined avatar groups.

17. A computer program product comprising computer-readable instructions which, when loaded into a memory of a computer and executed by the computer, cause the computer to perform a method according to claim 1 .

18. A device for providing at least one cutting pattern of a garment to be made individually for a customer, comprising:
a processor configured to:
create a virtual 3D body model of the customer on the basis of individually determined 3D body shell data of the customer and given general skeletal data,
create a virtual individual 3D garment on the basis of a virtual 3D ideal design and the virtual 3D body model, and
create the at least one cutting pattern by flattening/developing the virtual individual 3D garment, wherein flattening/developing the virtual individual 3D garment comprises, in this order, generating one or more possible cuts on the basis of a first set of cutting rules, generating one or more possible cuts on the basis of a second set of cutting rules, and generating one or more possible cuts on the basis of an automated flattening/development algorithm, the first set of cutting rules taking into account specified style elements of the garment and the second set of cutting rules taking into account specified effect elements of the garment.

19. The device according to claim 18, further comprising:
an avatar comparison database configured to store the created virtual individual 3D body model of the customer, the avatar comparison database comprising a large number of virtual individual 3D body models from different customers in order to compare the provided virtual individual 3D body models with one another.

20. The device according to claim 19, further comprising:
an avatar matching device configured to compare the created virtual individual 3D body model of the customer with other virtual individual 3D body models provided by the avatar comparison database.
